(19) United States
(12) Patent Application Publication
(10) Pub. No.: US 2026/0300290 A1
(43) Pub. Date: Oct. 1, 2026

(54) METHOD AND SYSTEM OF DATABASE MIGRATION

(71) Applicant: Avanade Holdings LLC, New York, NY (US)

(72) Inventors: Chaitra NAGARAJ, Bangalore (IN); Sabyasachi TRIPATHY, Cuttack (IN); Gargi Arun ULMAN, Mumbai (IN)

(73) Assignee: Avanade Holdings LLC, New York, NY (US)

(21) Appl. No.: 19/216,403

(22) Filed: May 22, 2025

(30) Foreign Application Priority Data
Mar. 27, 2025 (IN) 20254102912

(51) Int. Cl. G06F 16/2453; G06F 11/34; G06F 16/27

(52) U.S. Cl. CPC G06F 16/24539; G06F 11/3428; G06F 16/27

(57) ABSTRACT

The method for generative artificial intelligence (GenAI) powered database migration is disclosed. The method includes extracting a metadata structure of a database associated with a source system of a plurality of source systems. The database includes one or more of visuals, relations, tables, and dependencies. Based upon the metadata structure, a prompt for converting the metadata structure of the database associated with the source system into a corresponding metadata structure associated with a destination system is generated. Further, a response to the prompt is generated using a dynamic large language model. Herein, the response includes conversion of the metadata structure of the database associated with the source system to the metadata structure associated with the destination system. Consequently, based upon the response to the prompt, the database from the source system to the destination system is migrated.

### TECHNICAL FIELD

Various examples described herein relate generally to database migration. Specifically, disclosed examples are directed to a method and a system for generative artificial intelligence (GenAI) powered database migration.

### BACKGROUND

Database migration is the comprehensive process of transferring data, along with its associated definitions (schema) and stored procedures, from one database system to another. The database migration often necessitates modifications to applications to ensure compatibility with the new database environment. Organizations undertake database migrations for various reasons, including upgrading to a more advanced system, consolidating multiple databases into a single platform, transitioning to a cloud-based solution, or implementing changes to the database schema itself. The migration process involves a series of key steps, including, selecting the data to be moved, preparing and cleaning the data, extracting the data from the source database, transforming the data to conform to the target database's structure, and finally, loading the data into the new system. In today's competitive landscape, modernizing data platforms and analytics systems is crucial for organizations looking to optimize costs, enhance operational efficiency, and drive wider adoption of data-driven insights.

### SUMMARY

Implementations of the present disclosure are generally directed to database migration. More particularly, implementations of the present disclosure are directed to database migration, from a source system to a destination system using generative artificial intelligence (GenAI) and machine learning (ML).

In general, innovative aspects of the subject matter described herein provide a method for GenAI powered database migration. The method may include extracting a metadata structure of a database associated with a source system of a plurality of source systems. The database may include one or more of visuals, relations, tables, and dependencies. The method may further include, generating, based upon the metadata structure, a prompt for converting the metadata structure of the database associated with the source system into a corresponding metadata structure associated with a destination system. The method may include generating a response to the prompt using a dynamic large language model. The response may include conversion of the metadata structure of the database associated with the source system to the metadata structure associated with the destination system. Consequently, the method may include migrating, based upon the response to the prompt, the database from the source system to the destination system.

The present disclosure further describes a system for implementing the method provided herein. The present disclosure also describes non-transitory computer-readable medium (CRM) coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein but also include any combination of the provided aspects and features.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various examples in accordance with the present disclosure will be described with reference to the drawings, in which:

FIG. 1 illustrates an example environment used to execute implementations of the present disclosure.

FIG. 2 illustrates an example architecture of the back-end system for database migration, in accordance with implementations of the present disclosure.

FIG. 3 illustrates a block diagram representation of an intelligent orchestrator of FIG. 2, in accordance with implementations of the present disclosure.

FIG. 4 illustrates a block diagram representation of a prompt library of FIG. 2, in accordance with implementations of the present disclosure.

FIG. 5 illustrates the flow diagram of an example method for database migration, implemented by the back-end system, in accordance with implementations of the present disclosure.

FIG. 6 illustrates a computer system that may be used to implement database migration, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” (e.g., “for example”, “an example of”, “by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element. “First,” “second,” etc., are labels to distinguish components or blocks of otherwise similar names but does not imply any sequence or numerical limitation. “And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A. and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring details of the examples.

The specification and drawings are to be regarded in an illustrative rather than a restrictive sense. It will, however, be evident that various modifications and changes may be made thereunto without departing from the broader spirit and scope of the invention as set forth in the claims.

Many organizations face technical deb with legacy data systems often being a major contributor. To migrate from legacy data systems to modern age technical system includes effective data visualization and analysis, to gain insights and make informed decisions. This necessitates not only the acquisition of data but also its effective storage, processing, and utilization. Generative AI (GenAI) emerges as a key enabler for this database migration, offering potential to enhance data quality, streamline data integration processes, and accelerate data analysis.

Adapting GenAI for database migration can provide a significant competitive advantage. The use of GenAI may automate data mapping, validation, and transformation. GenAI streamlines the process of extracting, transforming, and loading (ETL) data from diverse source systems into a unified destination, thereby ensuring data consistency and integrity while integrating next-generation systems with legacy systems seamlessly.

Tradition methods of database migration face several significant technical challenges. For instance, traditional database migration methods are characterized by manual labor and significant time investment, demanding substantial human effort and specialized expertise. Integrating modern systems with legacy infrastructure presents considerable challenges due to compatibility issues and the limitations of existing databases. Furthermore, when inexperienced personnel undertake these tasks, the risk of errors and associated costs escalate. Traditional methods also introduce inherent risks, such as compromising sensitive data and failing to comply with industry standards. The outputs generated by traditional methods are often generic and require extensive effort from developers to fine-tune prompts and experiment with various approaches for optimal customization. Moreover, successful database migration, necessitate developers proficient in multiple programming languages, coupled with comprehensive training programs and robust management strategies.

Therefore, to address afore-mentioned challenges, there is a need for GenAI powered method and system that can improve efficiency, reduce risk, and enable organizations to effectively leverage the data.

Implementations of the present disclosure discloses a solution, including a method and a system for database migration using GenAI and machine learning (ML), to overcome above mentioned drawbacks of the traditional methods. The proposed solution is optimized for a wide array of reporting and data management tools, offering customizable solutions tailored to industry best practices. By integrating cutting-edge strategies and a robust framework for prompt engineering and refinement, the proposed solution delivers high-quality migration results while minimizing the need for extensive GenAI expertise. Further, the proposed solution implements metadata transformation, adhering to principles of responsible AI. Furthermore, the proposed solution incorporates user feedback mechanisms to establish and refine standards and guidelines, enabling the generation of tailored outputs and continuous evolution based on user input and feedback.

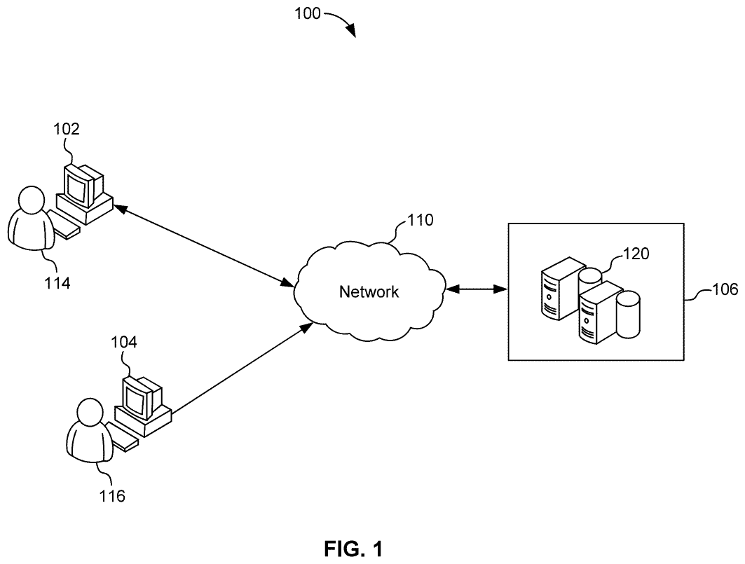

FIG. 1 depicts an example environment 100 that can be used to execute implementations of the present disclosure. In some examples, the example environment 100 enables users associated with respective systems to execute requests for database migration by invoking a trained large language model in accordance with implementations of the present disclosure. The example environment 100 includes computing devices 102 and 104, back-end system 106, and a network 110. In some examples, the computing devices 102 and 104 are used by respective users 114 and 116 to log into and interact with the back-end system 106 and applications executing on the back-end system 106 according to implementations of the present disclosure.

As shown in FIG. 1, the computing devices 102 and 104 are depicted as desktop computing devices. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites (e.g., web applications executing on the back-end system 106), user devices (e.g., the computing devices 102, 104), and the back-end system 106. In some examples, the network 110 can be accessed over a wired and/or a wireless communications link. For example, mobile computing devices, such as smartphones can utilize a cellular network to access the network 110.

While only one back-end system 106 is shown in FIG. 1, there may be more than one back-end system 106, and each of the back-end systems 106 includes at least one server system 120. In some examples, the server system 120 hosts one or more computer implemented services that users 114 and/or 116 can interact with by using the computing devices 102 and/or 104, respectively. For example, components of enterprise systems and applications can be hosted on one or more of the back-end system 106. In some examples, the back-end system 106 can be provided as an on-premises system that is operated by an enterprise or a third-party taking part in cross-platform interactions and data management. In some examples, the back-end system 106 can be provided as an off-premises system (e.g., cloud or on-demand) that is operated by an enterprise or a third-party on behalf of an enterprise.

In some examples, the computing devices 102 and 104 each include computer executable applications executed thereon. In some examples, the computing devices 102 and 104 each include a web browser application executed thereon, which can be used to display one or more web pages of applications executing on the back-end system 106. In some examples, each of the computing devices 102 and 104 can display one or more GUIs that enable the respective users 114 and 116 to interact with the back-end system 106. In accordance with implementations of the present disclosure, the back-end system 106 may host enterprise applications or systems that require data sharing and data privacy. In some examples, the computing device 102 and/or the computing device 104 can communicate with the back-end system 106 over the network 110.

In some implementations, the back-end system 106 can be implemented in a cloud environment. The back-end system 106 includes at least one server system (or server) 120. In the example of FIG. 1, the back-end system 106 can include various forms of servers including, but not limited to, a web server, an application server, a proxy server, a network server, and/or a server pool. In general, server systems accept requests for application services and provide such services to any number of client devices (for example, the computing device 102 over the network 110).

In some implementations, the back-end system 106 can be used to migrate database from the source system (not shown in FIG. 1) to the destination system (not shown in FIG. 1).

Various examples, depicting GenAI powered database migration, are described in detail in conjunctions with figures below.

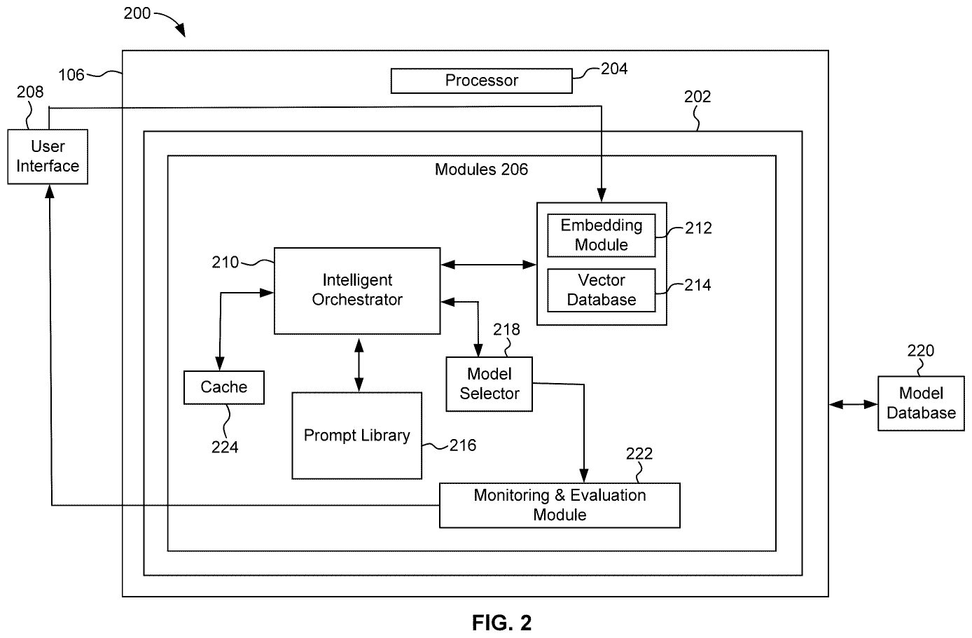

FIG. 2 illustrates an example architecture 200 of the back-end system 106 for database migration, in accordance with implementations of the present disclosure. The back-end system 106 may include one or more memory 202 storing machine-executable instructions and the one or more processors 204. The back-end system 106 may include one or more processors 204 communicatively coupled with the one or more memory 202 and configured to execute the machine-executable instructions. In some examples, the one or more processors 204 may include, but not limited to, microprocessors, microcomputers, hardware processors, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the one or more processors 204 may be programmed to cooperate with non-transitory computer-readable instructions stored in one or more memory 202 (also referred to be as computer-readable medium) for performing operations according to the present disclosure. The one or more memory 202 may be non-transitory or non-volatile medium, such as a magnetic disk or solid-state non-volatile memory or volatile medium such as Random Access Memory (RAM), and/or the like.

In some examples, the one or more memory 202 may include modules 206 in the form of programmable instructions executable by the one or more processors 204. The modules 206 may further include an intelligent orchestrator 210, an embedding module 212, a prompt library 216, a model selector 218, a monitoring and evaluation module 222 and a cache 224. Moreover, the back-end system 106 may be communicatively coupled to a model database 220. The model database 220 may serve as a central location for managing and accessing the AI models used for database migration. The AI model and large language model (LLM) are used interchangeably throughout the document.

In an aspect, for implementing database migration, the back-end system 106 may utilize GenAI and ML to reproduce a source intelligence technology file, in a source system, into an alternative selected intelligence technology file, in a destination system. Herein, the intelligent technology file may refer to the file including definitions, configurations, or code related to a specific data analysis or intelligence tool. The intelligent technology file may encapsulate the logic, structure, and metadata associated with data processes, reports, or visualizations created within the intelligence tool. For example, said database migration may include migration from SQL Server Integration Services (SSIS) to Fabric PySpark Notebook, SSIS to Dataflow Gen2, Oracle to Databrick Notebook, Synapse to Fabric Notebook, SQL Server Reporting Services (SSRS) to Power Business Intelligence (BI), Oracle Business Intelligence Enterprise Edition (OBIEE) to Power BI, Tableau to Power BI, and Cognos to Power BI.

In an example implementation, the back-end system 106 may receive input files associated with the source system of a plurality of source systems, via a user interface 208. The source system may be any one of a plurality of software suites for data analysis or data management. The non-limiting examples of the plurality of software suites may include OBIEE, Tableau, Cognos, and/or SAP business objects (BO). In some examples, the intelligent orchestrator 210 may extract a metadata structure of a database associated with said source system. The database may include visuals, relations, tables, and/or dependencies. The metadata structure may refer to the organized information about the database stored in the source system, such as table definitions, relationships between tables, data types, and constraints. Further, the visuals may refer to any visual representations of the data, such as diagrams, Entity-Relationship (ER) diagrams, or data flowcharts. The relations may refer to the relationships between different data entities (for example, one-to-one, one-to-many, many-to-many, etc.). The tables may refer to core components of the database, each holding a specific set of data. The dependencies may represent how different parts of the source system rely on each other. For example, a table might depend on another table for the data. In an example, the input may be a file, said file may include the metadata structure required for database migration from source system to destination system. The input file (or file) may include, but not limited to, XML-based SSIS/SSRS packages, report XML, SQL files, or any structured data in Extensible Markup Language (XML) or JavaScript Object Notation (JSON) formats. The intelligent orchestrator 210 is described further in detail in conjunction with FIG. 2.

The intelligent orchestrator 210 may transmit the metadata structure to the embedding module 212 for further processing. The embedding module 212 may further include a vector database 214. Specifically, the embedding module 212, by using vectorization, may transform the received metadata structure from the intelligent orchestrator 210, into vector embeddings and store said vector embeddings in the vector database 214. Vectorization may be a process of converting data, into numerical high-dimensional vectors, thereby facilitating efficient search and analysis along with determining the semantics of the data. Specifically, the vector embeddings may map the various data points included in the metadata structure, in a multi-dimensional space. The vectorization may include preprocessing of the metadata structure, said preprocessing may include, but not limited to, normalization, tokenization, removing irrelevant information and converting to a suitable format. The normalization may refer to standardization of metadata structure formats and values. The tokenization may refer to splitting text fields into individual words or subwords. Removing irrelevant information may refer to filtering out noise or unnecessary data. Converting to a suitable format may refer to transform the metadata structure into the format suitable for the embedding module 212. Thereafter, the embedding module 212 may utilize an appropriate embedding model depending on metadata structure data type, to generate vector embeddings of corresponding metadata structure. For instance, embedding models like Word2Vec, GloVe, or FastText, may be utilized, if the metadata includes significant textual information. Embedding models like sentence-bidirectional encoder representations from transformers (BERT) or universal sentence encoder, may be utilized, if the metadata structure needs to be represented as a whole.

Moreover, vector database 214 (for example, Pinecone, Milvus, Elasticsearch, Weaviate, and PostgreSQL with pgvector extension) may create indexes, by utilizing indexing techniques, such as approximate nearest neighbors (ANN), hierarchical navigable small worlds (HNSW) and product quantization (PQ), to store the vector embeddings. Herein, the index may refer to data structure to store and retrieve multidimensional vector data. The vector embeddings may enable faster searching where the search compares vectors. For example, when a query is received (to initiate database migration, including a new metadata structure to compare), the embedding module 212 may generates the vector embedding and uses the vector database's 214 indexing to find the most similar stored embeddings.

In some examples, the database migration may be initiated by raising a query via the user interface 208. Herein, said query may include information of, but not limited to, the source system, the destination system and data transformation requirements for the database migration. For example, the information of the source system may include a type of source system (e.g., database, file system, API, etc.), connection details (e.g., database credentials, file path, etc.) and/or specific tables or data sources within the source system. The information of destination system may include a type of destination system (e.g., database, data warehouse, data lake), connection details and destination schema or table names. The data transformation requirements may include required data transformations (e.g., data type conversions, data cleaning, data enrichment, and the like) and/or rules and constraints. Additionally, said query may include information of schedule for the migration (e.g., daily, weekly, on-demand, or the like), time windows for migration task execution, error handling mechanisms (e.g., retry attempts, notifications, rollback options, etc.), requirements for monitoring the migration process (e.g., progress tracking, performance metrics, etc.), logging preferences (e.g., detailed logs, summary reports, etc.), security requirements (e.g., encryption, access control, etc.) and/or compliance requirements (e.g., data privacy regulations, etc.). In an example, the query raised via the user interface 208 may be “Migrate data from the ‘Sales’ table in the ‘MySQL_Source’ database to the ‘Sales_History’ table in the ‘Azure_SQL_Target’ database, Convert the ‘OrderDate’ column from ‘DATE’ to ‘TIMESTAMP’, Ensure data integrity by checking for duplicates and applying the ‘Sales_Rules’defined in the configuration file”.

Furthermore, the query may be converted into the vector embeddings by the embedding module 212. Thereafter, the vector database 214 may perform a similarity search (for example, cosine-similarity) to retrieve the most relevant information. Specifically, the vector database 214 may calibrate the distances (lesser distance implies more similarity and vice versa) between the vector embeddings of query and vectors stored in the index.

Also, the prompt library 216 may serve as a repository of pre-defined prompts which may be used for the database migration. The intelligent orchestrator 210 may generate a prompt for the large language model, by using the prompt library, based on the migration task. The prompt template may include placeholders for variables to be filled in dynamically, thereby, enabling the prompts to be dynamically adjusted based on user input or other data sources. In an example, the prompt template may be expressed as below:

“Convert the schema of the ‘{source_table}’ table from the ‘{source_database}’ database to the ‘{destination_table}’ table in the ‘{destination_database}’ database. Specifically, perform the following data type conversions: ‘{data_type_conversions}’ Add the following constraints: ‘{constraints}’Please provide the resulting SQL DDL statement for the ‘{target_table}’table.”

The placeholder “{source_table}” may refer to the name of the table in the database of source system. The placeholder “{source_database}” may refer to the name of the database in the source system. The placeholder “{destination_table}” may refer to the name of table in the database of the destination system. The placeholder “{target_database}” may refer to the name of the database in the destination system. The placeholder “{data_type_conversions}” may refer to the list of data type conversions to be performed (e.g., “INT to BIGINT”, “VARCHAR(255) to TEXT”). The placeholder “{constraints}” may refer to the list of constraints to be added (e.g., “PRIMARY KEY (CustomerID)”, “FOREIGN KEY (OrderID) REFERENCES Orders(OrderID)”).

If the query raised by user includes conversion of the “Customers” table from a MySQL database named “SourceDB” to a PostgreSQL database named “DestinationDB”, and renaming of the table to “Clients”, the prompt template may be filled in as below: “Convert the schema of the ‘Customers’ table from the ‘SourceDB’ database to the ‘Clients’ table in the ‘DestinationDB’ database. Specifically, perform the following data type conversions: ‘CustomerID’ INT to BIGINT, ‘CustomerName’ VARCHAR(255) to TEXT. Add the following constraints: PRIMARY KEY (CustomerID). Please provide the resulting SQL DDL statement for the ‘Clients’table.”

Consequently, the intelligent orchestrator 210 may utilize said filled-in prompt to instruct the LLM to perform the required database migration.

Specifically, intelligent orchestrator 210 may generate the prompt for converting the metadata structure of the input files included in the database of the source system to the corresponding destination system, based upon the extracted metadata structure. The conversion may include, but not limited to, schema conversion, data type conversion and constraint mapping. The schema conversion may refer to translating data types, table names, and relationships to match the destination system database's schema. The data type conversion may refer to converting data types between different database systems (for example, from VARCHAR to TEXT). The constraint mapping may refer to ensuring that the constraints (for example, primary keys, foreign keys, unique constraints, or the like) are defined in the destination system's database.

Furthermore, the prompt generation may include curating the prompt using reinforcement learning techniques until a respective score of the prompt satisfies a threshold condition. The prompt curation may refer to the process of optimizing and refining the prompts (generated by the intelligent orchestrator 210), thereby ensuring the said prompts may produce the desired output from the AI model. The reinforcement learning techniques may refer to AI techniques which learn by interacting with an environment. Herein, the environment may be the AI model itself. The intelligent orchestrator 210 may generate prompts, observe the AI model's response, and receive the respective score (a reward or penalty) based on the quality of the response. In an aspect, a subject matter expert (SME) or the user may evaluate the AI model's response. The SME may assign a positive score (reward) to the prompt. The positive score may reinforce the effectiveness of the prompt. Moreover, the SME may assign a negative score (penalty) to the prompt. The negative score may indicate that the prompt needs improvement. The prompt library 216 may be updated with the generated prompts and the associated score. Further, the SME may provide negative feedback and said negative feedback may be incorporated into the prompt as an instruction. The prompt may automatically be curated (modified) until the prompt meets the threshold. The curation of prompt may include, for example, adding constraints, clarifying ambiguous instructions, providing examples, modifying the structure of the prompt, or the like.

Over time, the intelligent orchestrator 210 may learn to generate prompts which consistently produce desired results. In other words, the reinforcement learning techniques may iteratively update the prompt based on the respective score received. The respective score may quantify the quality of the AI model generated migration task instructions based on the prompt. based on plurality of potential metrics. The plurality of potential metrics may include, but not limited to accuracy of the generated response, data loss or corruption, migration time and compliance with constraints. Herein, the accuracy of the generated response may refer to similarity of the AI model-generated response matches the desired destination system. The data loss or corruption may refer to the amount of data lost or corrupted during the migration process. The migration time may refer to the speed and efficiency of the migration process. The compliance with constraints may ensure that the migration task adhere to constraints or requirements of the migration process. In an example, if the AI model response includes instructions that result in a high data loss, the reinforcement learning techniques may modify/update the prompt to discourage similar outputs in the future. Further, the threshold condition may refer to a specific level of performance that the prompt must achieve. For instance, the threshold may be a minimum accuracy score for the generated response, a maximum data loss rate, or a specific migration time. The reinforcement learning techniques may continue to refine the prompt until the respective score received satisfies the defined threshold condition.

In another aspect, the prompt may be assigned the score (Ps) using the following expression:
Prompt Score (Ps)=Similarity Score(S)+(W*Like Counts)−(W*Dislike Counts),
   wherein,
   similarity score(S) may denote a measure of similarity the prompt is to other successful prompts;
   like counts may denote the number of positive feedback scores;
   dislike counts may denote the number of negative feedback scores; and
   W may denote the complexity factor to adjust the weight of the feedback based on the database migration's complexity (simple, medium, complex).

In an example, the intelligent orchestrator 210 may generates the initial prompt “Convert the ‘Sales Dashboard’ from Tableau to Power BI”. The AI model may generate the basic conversion but may lacks one or more filters and calculated fields. The SME may provide the negative score, thereby indicating the prompt needs modification. Additionally, the SME may add feedback “Include all filters and calculated fields from the Tableau”. Based on the negative score and the feedback, the prompt may be curated (or updated) as “Convert the ‘Sales Dashboard’ from Tableau to the target platform. Include all filters and calculated fields from the Tableau”. The initial prompt may get the negative score. The curated prompt may receive the similarity score (based on existing prompts) and positive/negative scores from future tests. The complexity factor (W) may be set based on the complexity of the database migration (that is, Tableau to Power BI). The AI model may generate a new response based on the curated prompt. Following, the SME may review the response generated to the curated prompt and assign the score. If the curated prompt is assigned the negative score, the process repeats. The prompt library 216 may be populated with both the initial and curated prompts, along with the associated scores. If the curated prompt meets the acceptable threshold the curated prompt may be then used in future similar migrations

Thereafter, the model selector 218 may select the most suitable large language model, from the model database 220, for the given migration task. The most suitable large language model may be selected based on the factors like, but not limited to, model size, performance, and cost. Specifically, the model selector 218 may be communicably coupled to the model database 220. The model database 220 may include one or more LLMs (also be referenced to as GenAI models, foundation models, natural language processing (NLP) model and/or the like). In an implementation, the LLMs may include pre-trained LLMs or generated LLMs. The pre-trained LLMs may be general-purpose GAI models like large deep learning neural networks, which may be trained using a broad range of generalized and unlabelled training data to perform one or more tasks, such as, human computer interactions (i.e., question and answering), automating process execution, process planning, generating step-by-step procedures for the process execution, performing data analysis, and/or the like. While implementations of the present disclosure are described in further detail herein with non-limiting reference to the LLMs, it is contemplated that implementations of the present disclosure may be realized using any appropriate foundation models or Machine Learning (ML) models, or Artificial Intelligence (AI) models.

The selected AI model from the model database 220 may generate a response to the prompt (generated by the intelligent orchestrator 210) using a dynamic large language model. The response may include conversion of the metadata structure of the database associated with the source system to the metadata structure associated with the destination system. Specifically, the selected AI model may receive the prompt generated by the intelligent orchestrator 210. The generated prompt may provide instructions, to the selected AI model, corresponding to the migration task initiated by the user. In an aspect, the AI model may be a dynamic large language model. The dynamic large language model may refer to the AI model that can adapt and change the response based on various factors, said factors including, but not limited to, types of databases involved (e.g., relational, NoSQL, data warehouse, etc.), volume and type of the data to be migrated (e.g., number of tables, relationships, data types, data quality) and extent of differences between the source and destination systems (e.g., data type conversions, table restructuring, constraint mapping, etc.). In further detail, generating the response to the prompt may include using the dynamic large language model. The model selector 218 may select said dynamic large language model by implementing a dynamic LLM selection mechanism, where the optimal model may be selected as the dynamic large language model, from the model database 220 through rigorous evaluation. The evaluation may include comparing large language models (LLMs) against a set of ground truth comparisons, ensuring the selected dynamic large language model may align with the input's technical category and delivers high-quality results with efficient token usage. The ground truth may refer to a set of known correct or expected outcomes for specific migration task. For example, said ground truth may include manually created schema conversions, results from previous successful migrations and expert-defined rules and best practices, etc. The AI model responses for ground truth comparisons may initially be generated from high end AI models for example, GPT 4 and GPT 4 Turbo. The responses from the said high end AI models may serve as a benchmark for evaluating the large language model in terms of quality. Moreover, the model selector 218 may evaluate the performance of each large language model in the model database 220 by comparing their generated responses to the ground truth comparisons. The evaluation may be based on metrics such as, but not limited to, accuracy, data loss, migration time and compliance with constraints. By comparing the performance of different large language models against the ground truth, the model selector 218 may establish said benchmark, thereby allowing the selection of dynamic large language model for the given migration task.

Furthermore, the model selector 218 may select the dynamic large language model based upon evaluating the one or more large language models across a plurality of prompt variations of the prompts generated by prompt refinements such that a prompt variation of the plurality of prompt variations meets a pre-defined score condition. The model selector 218 may start with an initial prompt. Thereafter, the model selector 218 may generate variations of said initial prompt by utilizing techniques like parameter tuning, rewording and context addition. In an aspect, low end AI models for example GPT 3.5 may be subjected to prompt refinements/synthesis so as to auto generate different prompt variations that boost up the score to the desired level. The levels determined by the high-end models act as benchmarks. Herein, parameter tuning may refer to adjusting parameters within the prompt (e.g., changing the level of detail, specifying constraints, and/or providing different examples, etc.). Rewording may refer to re-phrasing the prompt using different vocabulary or sentence structures. Context addition may refer to incorporating additional information or context into the initial prompt.

For example, the initial prompt may be “Convert the following SQL Server stored procedure to a PostgreSQL function: [SQL Server Stored Procedure Code]”. By utilizing parameter tuning techniques, the model selector 218 may generate below expressed variations of said initial prompt:
“Convert the following SQL Server stored procedure to a PostgreSQL function. Ensure that all data type conversions are explicitly defined: [SQL Server Stored Procedure Code]” (the prompt variation may add a specific constraint)
“Convert the following SQL Server stored procedure to a PostgreSQL function. Provide a detailed explanation of each conversion step: [SQL Server Stored Procedure Code]” (the prompt variation may request a specific level of detail).

Further, by utilizing the rewording techniques, the model selector 218 may generate below expressed variation of said initial prompt:
“Translate the SQL Server stored procedure below into an equivalent PostgreSQL function: [SQL Server Stored Procedure Code]” (the prompt variation may change the phrasing).

Moreover, by utilizing the context addition techniques, the model selector 218 may generate below expressed variation of said initial prompt:
“Considering that the target PostgreSQL database uses a ‘public’ schema, convert the following SQL Server stored procedure to a PostgreSQL function: [SQL Server Stored Procedure Code]” (the prompt variation may add context about the database of target system).

Each prompt variation may be input to the intelligent orchestrator 210. The intelligent orchestrator 210 may generate response for each prompt variation. The model selector 218 may, further evaluate the quality of each response using the pre-defined score condition. Specifically, the pre-defined score condition may be pre-defined in the model selector 218. For instance, the pre-defined score condition may be a threshold value for a specific metric (e.g., accuracy above 95%), or a combination of different metrics. The model selector 218 may iteratively refine the prompts and evaluates the dynamic large language model responses until prompt variation is found meeting the pre-defined score condition. Consequently, the dynamic large language model generating the desired response based on the prompt variation meeting the pre-defined score condition may be selected for the given migration task.

The prompt may specify the desired outcome, which is the conversion of the source system's metadata structure to the destination system's structure. The dynamic large language model may process the prompt using mechanisms such as, attention mechanisms, transformers models, or the like. Herein, the attention mechanisms may enable the dynamic large language model to analyze the prompt while generating the output (database migration instructions). Thus, the attention mechanism may facilitate determining the context and relationships within the prompt, such as the source and destination database types, specific data transformation requirements, and any constraints. Moreover, transformer models, for example BERT and GPT, may implement natural language processing. The implementation of natural language processing may include utilizing self-attention mechanisms to process long sequences and capture relationships between different parts of the input. The transformers may analyze the prompt, understand the relationships between different components of the source and destination schemas, and generate accurate and comprehensive database migration instructions.

Additionally, the dynamic large language model may utilize the pre-trained knowledge, and the information encoded within the prompt to determine said migration task. Specifically, the dynamic large language model may be trained on massive amounts of text and code data. As a result, the dynamic large language model may gain information of programming languages, data structures and formats and database migration concepts. Herein, the information of programming languages may include syntax, semantics, and patterns in SQL, Python, and other languages relevant to database operations. The information of data structures and formats may include various data formats (e.g., relational databases, NoSQL, JSON, XML), related schemas, and common operations. The information of database migration concepts may include information of common migration tasks (e.g., schema conversion, data type conversion, data cleansing, data loading, etc.). The pre-trained knowledge may provide the dynamic large language model with a foundational knowledge of the database migration domain, thereby enabling to interpret prompts and generate relevant instructions for database migration. Furthermore, the information encoded within the prompt may include information of source and destination systems (e.g., types, schemas, connection details), data to be migrated, transformation requirements and constraints and rules.

Moreover, the dynamic large language model may analyze the metadata structure provided in the prompt. The analysis of metadata structure may further include determining schema definition (table names, column names, data types, and relationships between tables), constraints (primary keys, foreign keys, unique constraints, and other rules) and data types (specific data types used in the source system). Specifically, the dynamic large language model may analyze the prompt to extract information and determine the specific requirements of the migration task, including, identifying the migration task, extracting relevant information and interpreting constraints and rules. The identification of the migration task may refer to determining the specific type of migration task (e.g., schema conversion, data loading, data cleansing, or the like). The extraction of relevant information may refer to identifying the source and target systems, data to be migrated, and any specific requirements. By combining the pre-trained knowledge with the information encoded within the prompt, the dynamic large language model may determine the specific steps and actions required to execute the migration task. For instance, said specific steps and actions required may include creating or modifying SQL statements for creating tables, altering columns, and defining constraints in the destination system database. The specific steps and actions required may further include specifying data type conversions, data cleaning rules, and other data transformations. The specific steps and actions required may also include defining the sequence of steps involved in the migration process (e.g., data extraction, transformation, loading, validation).

Furthermore, based on the prompt and the analysis of the source system metadata, the dynamic large language model may generate the response outlining the necessary changes to the schema of source system to adapt to the destination system. The changes may include, but not limited to, renaming tables and columns, modifying data types, creating or modifying relationships and adding or removing constraints. The renaming tables and columns may be implemented to align with naming conventions in the destination system. Modifying data types may include converting data types to compatible types in the destination system. Creating or modifying relationships may include modifying key constraints and other relationships between tables to match the destination system. Adding or removing constraints may include implementing constraints specific to the destination system. The response generated by the dynamic large language model may be in in a structured format, for example, Data Definition Language (DDL) statements, JSON or Yet Another Markup Language (YAML), a combination of text and/or code. DDL may refer to SQL statements to create or modify tables, columns, and constraints in the target database. JSON or YAML may refer to structured format which represents the destination system's database schema. The combination of text and/or code may include both textual description of the changes and the corresponding SQL statements.

In an example, the prompt generated by the intelligent orchestrator 210 may be as below:
Convert the metadata of the ‘Customers’ table from the MySQL source database to the PostgreSQL target database. The ‘CustomerID’ column should be changed from Integer (INT) to Universally Unique Identifier (UUID). Add a new column ‘LastUpdatedTimestamp’ of type TIMESTAMP WITH TIME ZONE.

The generated response from the dynamic large language model, to said prompt may be as below:
CREATE TABLE Customers (
   CustomerID UUID PRIMARY KEY,
   CustomeNname VARCHAR(255),
   -- . . . other columns . . .
   LastUpdatedTimestamp TIMESTAMP WITH TIME ZONE
      );

Moreover, the response to the prompt may include a paginated and interactive report of the conversion of the metadata structure. The paginated report may refer to the presentation of the dynamic large language model generated response for source system database metadata conversion in a structured, multi-page format, thereby generating the information which is easier to navigate for users. In other words, the paginated report may provide structured and organized presentation of the generated response, thereby making it easier for database administrators, developers, and other stakeholders to understand and review the proposed metadata conversion plan. Specifically, the response may be divided into multiple pages or sections, making easier to navigate and consume large amounts of information, particularly when dealing with migrations involving numerous tables, relationships, and constraints. Each page may focus on a specific aspect of the metadata conversion, such as, but not limited to, schema changes for a particular table, data type conversions for specific columns, constraints and indexes that need to be created or modified and summary of the overall migration plan. Additionally, the paginated report may include pages organized in a logical order, guiding the user through the information in a clear and concise manner. Each page may further present information in structured format, such as tables, lists, or code blocks.

Further, the interactive report may include interactive elements to enhance usability and exploration. The interactive elements may include drill-down capabilities, visualizations, filtering and sorting, and search functionality. Herein, the drill-down capabilities may enable users to click on specific elements (e.g., a table name, a column, etc.) to view detailed information, such as data types, constraints, and relationships. The visualizations may include the use of charts, graphs, and/or diagrams to represent the source and destination system's schemas, highlighting the changes made during the conversion process. The filtering and sorting may enable users to filter the report based on specific criteria (e.g., table names, data types, etc.) and sort the results for better organization. The search functionality may enable users to quickly find specific information within the report. In essence, the paginated and interactive format enhances readability and makes the report more engaging for users. Visualizations and interactive elements may enable users better understand the proposed schema changes and the overall migration plan. Moreover, the report may be shared with stakeholders, facilitating better communication and collaboration. Interactive features may enable users to explore different aspects of the migration and make informed decisions based on the presented information.

In an aspect, the cache 224 may be provided for caching the prompt and the response for reuse during migration of the database from the source system to the destination system. The cache 224 can be implemented using various data structures, such as, but not limited to, in-memory cache, disk-based cache and hybrid approach. In-memory cache may be implemented for high-performance, low-latency access (for example, using libraries like Redis). The disk-based cache may be implemented for storing larger amounts of data and persisting the cache between system restarts. Hybrid approach may include combining in-memory and disk-based caching for optimal performance and storage capacity. In further detail, unique identifiers may be assigned to each prompt to enable efficient retrieval from the cache 224. The unique identifiers may be based on the database types of the source and destination systems, schema information, and other relevant parameters. The cache 224 may store the corresponding response generated by the AI model for each prompt. The response may be stored in various formats, such as text (e.g., SQL code, migration instructions), JSON or XML (for structured data) and serialized objects.

The cache 224, thus, may improve performance by reducing the need for on-demand content generation, especially for complex or frequently accessed assets. Before generating a new prompt, the intelligent orchestrator 210 may checks if a matching prompt already exists in the cache 224. If a match is found, the cached response is retrieved and used directly, eliminating the need to regenerate the response using the AI model. If no match is found a new prompt is generated, the AI model may generate the response, and the prompt-response pair may be added to the cache 224. When the new prompt-response pair is generated, said prompt-response pair may be added to the cache 224 for updation by using techniques such as write-through and write-behind. The write-through technique may be used to update the cache 224 and the underlying storage simultaneously. The write-behind technique may be used to update the cache 224 first and then update the underlying storage asynchronously.

Moreover, the monitoring and evaluation module 222 may continuously monitors the response generated from the selected dynamic large language model in the model database 220. Based on the response generated to the prompt, the back-end system 106 may initiate the migration of data from the source system to the destination system. Specifically, the back-end system 106 may analyze the dynamic large language model's response. The response may include SQL statements for creating tables, altering columns, and defining constraints in the destination database, instructions for data type conversions, mapping rules for relationships between tables and/or specific instructions for handling data during the migration (for example, data cleansing, data transformation, etc.). In further detail, the back-end system 106 may execute SQL statements to create or modify the schema in the destination database. The execution may include but is limited to creating tables and columns with the specified data types and defining primary keys, foreign keys, and other constraints. The execution may further include adjusting table and column names as per the prompt generated by the intelligent orchestrator 210.

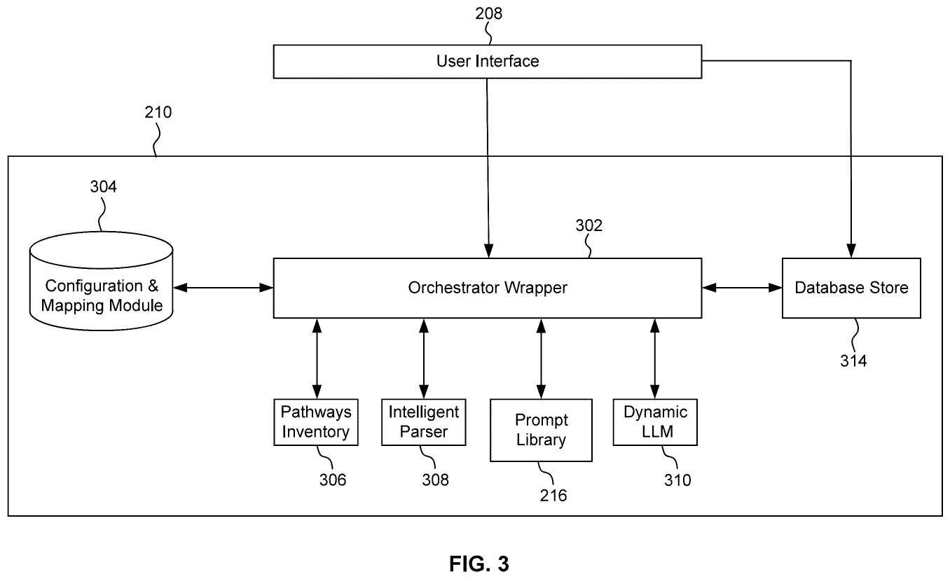

FIG. 3 illustrates a block diagram representation of the intelligent orchestrator 210 of FIG. 2, in accordance with implementations of the present disclosure. The intelligent orchestrator 210 may further include an intelligent orchestrator wrapper 302, a configuration & mapping module 304, a pathways inventory 306, an intelligent parser 308, and the dynamic large language model (LLM) 310. The user may provide input via the user interface 208 to define the migration task, upload input files, and configure the migration process. The migration task may be defined by specifying pathway type, source name, destination name and input file path. Herein, the pathway type may refer to type of data transformation (for example, data cleansing, enrichment, migration, etc.). The source name may refer to the origin of the data (for example, database, file, etc.). The destination name may refer to destination for the transformed/migrated data. Input file path may refer to location of the source data. The configuration and mapping module 304 may reads the pathway configurations from source system's database and may invoke the APIs for the components pathways inventory 306, intelligent parser 308 and dynamic LLM 310. Herein, the pathways inventory 306 may store the details of the pathways maintained. Moreover, the configuration and mapping module 304 may store pre-defined configurations, mappings, and rules for various data transformations. For instance, the configuration and mapping module 304 may store pre-defined configurations, mappings, and rules for various data transformations. Further, the intelligent orchestrator wrapper 302 may receive the user input and manage the extraction of the metadata structure of database associated with the source system (said database including of visuals, relations, tables, and/or dependencies). The intelligent orchestrator wrapper 302 may manage said extraction of metadata structure by retrieving relevant configurations from the configuration & mapping module 304.

Further, once the intelligent orchestrator wrapper 302 receive the input, the intelligent parser 308 may parse the input. For instance, the input may include files related to data reporting and extraction, such as XML-based SSIS/SSRS packages, report XML, SQL files and/or structured data in XML or JSON. The XML-based SSIS/SSRS packages may include configuration files for data integration and reporting tools. The report XML may include XML-based representations of reports, used for defining report layouts and data source. The SQL files may include scripts containing SQL queries for data retrieval and manipulation. The structured data in XML or JSON may include data represented in structured format using markup languages. The intelligent parser 308 may parse the input file, breaking it down into smaller, manageable chunks, by utilizing a parsing logic. The parsing logic may implement a schema-agnostic approach, dynamically adapting to diverse metadata formats (XML, JSON, etc.) through runtime inference of data structures and semantic relationships. The parsing logic may further include intelligent chunking, said intelligent chunking may break complex inputs into logical segments based on contextual analysis and fine-tuned rules, thereby, optimizing processing efficiency. Moreover, the parsing logic may include a hybrid parsing strategy, said hybrid parsing strategy may combine lexical analysis with GenAI, thereby, improving the accuracy of data extraction and input classification, ensuring fine-tuned interpretation and mapping to relevant metadata elements. The intelligent parser 308 may recognizes that different reporting tools (SSIS, SSRS, etc.) have distinct syntax, structures, and metadata representations. The parsing logic may adapt dynamically to said syntax, ensuring accurate and efficient processing. Moreover, the intelligent parser 308 may be trained on a wide range of scenarios involving various reporting tools and platforms, thereby enabling the intelligent parser 308 to learn and adapt the parsing logic to new and unfamiliar input types. Furthermore, the parsed data may be stored in structured format, such as SQL tables or Azure Blob Storage, in a database store 314, thereby making the parsed data readily accessible for downstream processes. During parsing, the intelligent parser 308 may extract metadata such as visuals, relations, tables, and dependencies. The metadata may be stored in the database store 314 and may serve as an inventory for further processing. In essence, the intelligent parser 308 may optimizes the metadata extraction and structuring process, thereby making it efficient and scalable to handle large volumes of data and complex reporting scenarios.

Moreover, the intelligent orchestrator wrapper 302 may generate a prompt by accessing the prompt library 216 and guide the dynamic large language model in performing migration tasks. The dynamic LLM 310 (selected by the model selector 218) may process the generated prompts and generate instructions or code for the data transformation.

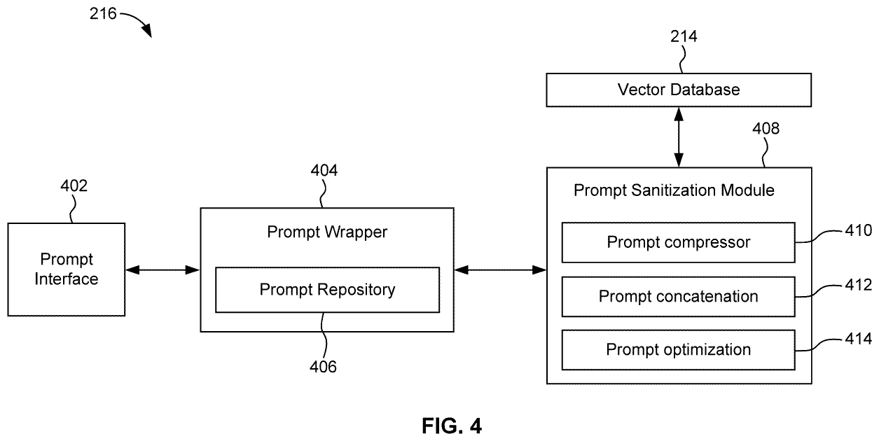

FIG. 4 illustrates a block diagram representation of the prompt library 216 of FIG. 2, in accordance with implementations of the present disclosure. The prompt library 216 may further include a prompt interface 402. The prompt interface 402 may receive data or chunks as input (from the intelligent orchestrator 210), along with contextual information like the pathway (which might represent the specific task or domain). A prompt wrapper 404 may encapsulate the prompt generation logic. The prompt wrapper 404 may further include a prompt repository 406. The prompt repository 406 may store a collection of pre-defined prompts, customized prompts, and prompt templates. Specifically, the prompt wrapper 404 may generate prompt for converting the metadata structure of the database associated with the source system into the corresponding metadata structure associated with the database of the destination system from the prompt repository 406. The generated prompt may be transmitted to the prompt sanitization module 408. The prompt sanitization module 408 may ensure the quality and safety of the generated prompts by removing or modifying potentially harmful or irrelevant content. The prompt sanitization module 408 may further include a prompt compressor 410, a prompt concatenation module 412 and a prompt optimizer 414. Specifically, the prompt sanitization module 408 may utilize techniques (e.g., prompt compression, concatenation, optimization, sanitization) to generate a curated prompt. Specifically, the prompt compressor 410 may reduce the length of the prompt while preserving the information. The prompt compression may maintain the prompt within the dynamic LLM's 310 token limits, thereby improving processing efficiency. The prompt compressor 410 may utilize keyword extraction libraries (for example, NLTK, YAKE, PKE, KeyBERT, rake-nltk, or the like) to identify and retain key terms, removing redundant words or phrases. The prompt compressor 410 may utilize text summarization algorithms (for example BERT extractive summarization, TextRank or the like) to condense lengthy instructions into concise summaries. Furthermore, the prompt concatenation module 412 may combine multiple smaller prompts or pieces of information into single, cohesive prompt by utilizing string manipulation and template processing techniques, using programming languages like Python. The prompt optimizer 414 may fine-tune the prompt's structure, wording, and formatting to improve the clarity, specificity, and effectiveness. The curated prompt may be stored in the vector database 214 along with associated metadata. The generated curated prompt may be further used to interact with the dynamic LLM 310 to obtain the desired output.

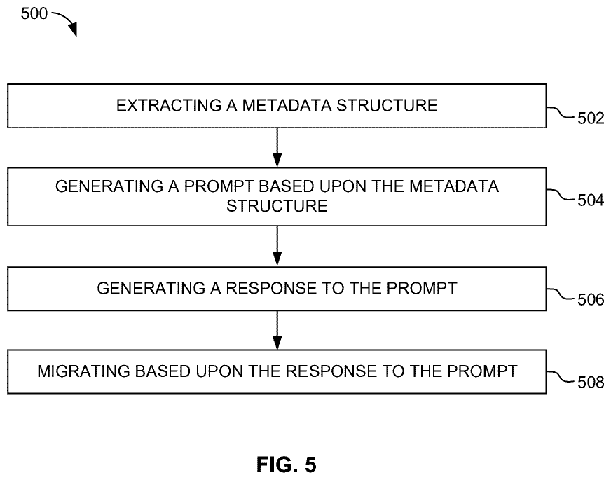

FIG. 5 illustrates a flow diagram of an example computer-implemented method 500 for database migration implemented by the back-end system 106, in accordance with implementations of the present disclosure. In some examples, the computer-implemented method 500 may be executed using the one or more processors 204 disclosed in related to FIGS. 1-3.

The computer-implemented method 500 include extracting 502 the metadata structure of the database associated with the source system of the plurality of source systems. The database may include visuals, relations, tables, and dependencies. The source system may include the plurality of software suites for data analysis or data management, and the destination system may include the plurality of software suites having different version as of the source system.

The computer-implemented method 500 may include generating 504, based upon the metadata structure, the prompt for converting the metadata structure of the database associated with the source system into the corresponding metadata structure associated with the destination system. Generating the prompt may include curating the prompt using reinforcement learning techniques until the respective score of the prompt satisfies a threshold condition. Furthermore, the computer-implemented method 500 may include caching the prompt and the response for reuse during migration of the database from the source system to the destination system.

The computer-implemented method 500 may include generating 506 the response to the prompt using the dynamic large language model. Herein, the response may include conversion of the metadata structure of the database associated from with the source system to the metadata structure of data associated with the destination system The dynamic large language model may be selected based upon evaluating the large language model using a plurality of ground truth comparisons acting as the benchmark. Moreover, the dynamic large language model may be selected based upon evaluating the one or more large language models across the plurality of prompt variations of the prompt generated by prompt refinements such that a prompt variation of the plurality of prompt variations meets a pre-defined score condition. Herein, the response to the prompt may include a paginated and interactive report of the conversion of the metadata structure.

The computer-implemented method 500 may include migrating 508 based upon the response to the prompt, the database from the source system to the destination system. Specifically, by utilizing the generated response (at 506), the back-end system 106 may execute the migration, including, but not limited to, schema creation/modification, data extraction, data transformation and data loading. The schema creation/modification may include replicating or transforming the database schema in the destination system. The data extraction may include retrieving data from the source database. The data transformation may include applying necessary changes to the data as defined in the prompt. The data loading may refer to writing the transformed data to the destination database. For example, said database migration may include migration from SQL Server Integration Services (SSIS) to Fabric PySpark Notebook, SSIS to Dataflow Gen2, Oracle to Databrick Notebook, Synapse to Fabric Notebook, SQL Server Reporting Services (SSRS) to Power Business Intelligence (BI), Oracle Business Intelligence Enterprise Edition (OBIEE) to Power BI, Tableau to Power BI, and Cognos to Power BI.

Implementations of the present disclosure provide technical advancements in the context of database migration. For example, in the present disclosure, the method and system for database migration is reporting tool agnostic as the method is based on metadata conversion from one structured format to another using GenAI. Specifically, the present disclosure may include extraction the metadata structure of the database associated with the source system. The database may include visuals, relations, tables, dependencies etc. The prompt of destination system may be fine-tuned to the metadata structure. This enabled the migration from source system to destination system in automated manner.

Moreover, the present disclosure may include curating the prompt using reinforcement learning techniques. The reinforcement learning techniques may learn through trial and error, iteratively refining the prompt based on feedback from the dynamic large language model and the migration process. By optimizing the prompts, the reinforcement learning techniques may significantly improve the accuracy of the dynamic large language model generated migration instructions, minimizing errors and ensuring data integrity. Thus, the adaptive learning process leads to the generation of highly effective prompts that produce the desired response.

By providing a paginated and interactive report of the metadata conversion, the back-end system 106 may enhances the user experience and facilitates accurate implementation of the migration task. The present disclosure may enable users to explore and interact with the information in a meaningful way.

In the present disclosure, the intelligent parser 308 utilizes the power of Generative AI to intelligently parse and process diverse input files, enabling efficient data extraction and structuring for downstream applications. By adapting to the specific characteristics of different reporting tools and leveraging machine learning, the intelligent parser 308 may provide a robust and scalable solution for managing data extraction tasks.

Moreover, the dynamic large language model may leverage the pre-trained knowledge as foundation and then may utilize the information provided in the prompt to tailor the response to the specific requirements of the database migration task. The dynamic interpretation of the prompt enables the dynamic large language model to generate accurate and relevant migration instructions.

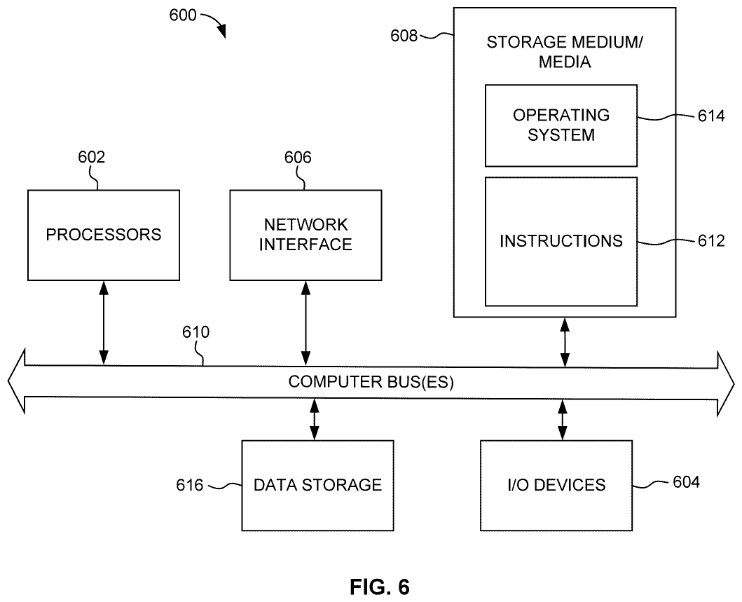

FIG. 6 illustrates a computer system 600 that may be used to implement the back-end system 106 disclosed in the example environment of FIG. 1. for database migration, in accordance with implementations of the present disclosure. More particularly, computing machines such as desktops, laptops, smartphones, tablets, and wearables which may be used to implement the tasks that may have the structure of the computer system 600. The computer system 600 may include additional components not shown and that some of the process components described may be removed and/or modified. In another example, a computer system 600 may be deployed on external-cloud platforms such as cloud, internal corporate cloud computing clusters, organizational computing resources, and/or the like.

The computer system 600 includes processor(s) 602, such as a central processing unit, ASIC or another type of processing circuit, input/output devices 604, such as a display, mouse keyboard, etc., a network interface 606, such as a Local Area Network (LAN), a wireless 802.11x LAN, a 3G or 4G mobile WAN or a WiMax WAN, and a computer-readable medium 608. Each of these components may be operatively coupled to a bus 610. The computer-readable medium 608 may be any suitable medium that participates in providing instructions to the processor(s) 602 for execution. For example, the computer-readable medium 608 may be non-transitory or non-volatile medium, such as a magnetic disk or solid-state non-volatile memory or volatile medium such as RAM. The instructions or modules stored on the computer-readable medium 608 may include machine-readable instructions 612 executed by the processor(s) 602 that cause the processor(s) 602 to perform the methods and functions of the system for database migration.

The system may be implemented as software stored on a non-transitory processor-readable medium and executed by the processors 602. For example, the computer-readable medium 608 may store an operating system 614, such as MAC OS, MS WINDOWS, UNIX, or LINUX, and code for the system. The operating system 614 may be multi-user, multiprocessing, multitasking, multithreading, real-time, and the like. For example, during runtime, the operating system 614 is running and the code for the system is executed by the processor(s) 602.

The computer system 600 may include a data storage 616, which may include non-volatile data storage. The data storage 616 stores any data used or generated by the system.

The network interface 606 connects the computer system 600 to internal systems for example, via a LAN. Also, the network interface 606 may connect the computer system 600 to the Internet. For example, the computer system 600 may connect to web browsers and other external applications and systems via the network interface 606.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., a field programmable gate array (FPGA) or an application specific integrated circuit (ASIC)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer can include a processor for performing instructions and one or more memory devices for storing instructions and data. Generally, a computer will also include or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a cathode ray tube (CRT), liquid crystal display (LCD) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for generative artificial intelligence (GenAI) powered database migration, the computer-implemented method comprising:
extracting a metadata structure of a database associated with a source system of a plurality of source systems, wherein the database comprises at least one of visuals, relations, tables, and dependencies;
generating, based upon the metadata structure, a prompt for converting the metadata structure of the database associated with the source system into a corresponding metadata structure associated with a destination system;
generating a response to the prompt using a dynamic large language model, wherein the response comprises conversion of the metadata structure of the database associated with the source system to the metadata structure associated with the destination system; and
migrating, based upon the response to the prompt, the database from the source system to the destination system.

2. The computer-implemented method of claim 1, wherein generating the prompt comprises curating the prompt using reinforcement learning techniques until a respective score of the prompt satisfies a threshold condition.

3. The computer-implemented method of claim 1, wherein the dynamic large language model is selected by evaluating one or more large language models using a plurality of ground truth comparisons acting as a benchmark.

4. The computer-implemented method of claim 1, wherein the dynamic large language model is selected based upon evaluating one or more large language models across a plurality of prompt variations of the prompt generated by prompt refinements such that a prompt variation of the plurality of prompt variations meets a pre-defined score condition.

5. The computer-implemented method of claim 1, wherein the response to the prompt comprises a paginated and interactive report of the conversion of the metadata structure.

6. The computer-implemented method of claim 1, wherein the source system is one of a plurality of software suites for data analysis or data management, and wherein the destination system is one of a plurality of software suites having different version as of the source system.

7. The computer-implemented method of claim 1, further comprising caching the prompt and the response for reuse during migration of the database from the source system to the destination system.

8. A system for generative artificial intelligence (GenAI) powered database migration, the system comprising:
at least one memory configured to store machine-executable instructions; and
at least one processor communicatively coupled with the at least one memory, and configured to execute the machine-executable instructions to perform operations comprising:
extracting a metadata structure of a database associated with a source system of a plurality of source systems, wherein the database comprises at least one of visuals, relations, tables, and dependencies;
generating, based upon the metadata structure, a prompt for converting the metadata structure of the database associated with the source system into a corresponding metadata structure associated with a destination system;
generating a response to the prompt using a dynamic large language model, wherein the response comprises conversion of the metadata structure of the database associated with the source system to the metadata structure associated with the destination system; and
migrating, based upon the response to the prompt, the database from the source system to the destination system.

9. The system of claim 8, wherein generating the prompt comprises curating the prompt using reinforcement learning techniques until a respective score of the prompt satisfies a threshold condition.

10. The system of claim 8, wherein the dynamic large language model is selected by evaluating one or more large language models using a plurality of ground truth comparisons acting as a benchmark.

11. The system of claim 8, wherein the dynamic large language model is selected based upon evaluating one or more large language models across a plurality of prompt variations of the prompt generated by prompt refinements such that a prompt variation of the plurality of prompt variations meets a pre-defined score condition.

12. The system of claim 8, wherein the response to the prompt comprises a paginated and interactive report of the conversion of the metadata structure.

13. The system of claim 8, wherein the source system is one of a plurality of software suites for data analysis or data management, and wherein the destination system is one of a plurality of software suites having different version as of the source system.

14. The system of claim 8, wherein the operations further comprise caching the prompt and the response for reuse during migration of the database from the source system to the destination system.

15. A non-transitory computer-readable media (CRM) comprising machine-executable instructions stored thereon, which, when executed by at least one processor of a computing device, cause the at least one processor in migration of data using generative artificial intelligence (GenAI) by performing operations comprising:
extracting a metadata structure of a database associated with a source system of a plurality of source systems, wherein the database comprises at least one of visuals, relations, tables, and/or dependencies;
generating, based upon the metadata structure, a prompt for converting the metadata structure of the database associated with the source system into a corresponding metadata structure associated with a destination system;
generating a response to the prompt using a dynamic large language model, wherein the response comprises conversion of the metadata structure of the database associated with the source system to the destination system; and
migrating, based upon the response to the prompt, the database from the source system to the destination system.

16. The non-transitory CRM of claim 15, wherein generating the prompt comprises curating the prompt using reinforcement learning techniques until a respective score of the prompt satisfies a threshold condition.

17. The non-transitory CRM of claim 15, wherein the dynamic large language model is selected by evaluating one or more large language models using a plurality of ground truth comparisons acting as a benchmark.

18. The non-transitory CRM of claim 15, wherein the dynamic large language model is selected based upon evaluating one or more large language models across a plurality of prompt variations of the prompt generated by prompt refinements such that a prompt variation of the plurality of prompt variations meets a pre-defined score condition.

19. The non-transitory CRM of claim 15, wherein the response to the prompt comprises a paginated and interactive report of the conversion of the metadata structure, and wherein the source system is one of a plurality of software suites for data analysis or data management, and wherein the destination system is one of a plurality of software suites having different version as of the source system.

20. The non-transitory CRM of claim 15, wherein the operations further comprise caching the prompt and the response for reuse during migration of the database from the source system to the destination system.
